(19) United States
(12) Patent Application Publication
(10) Pub. No.: US 2002/0049065 A1
(43) Pub. Date: Apr. 25, 2002

(54) Method and system for distributing intelligent network services in a mobile system

(76) Inventor: Jukka Wallenius, Helsinki (FI)

Correspondence Address: Altera Law Group, Suite 100, 6500 City West Parkway, Minneapolis, MN, 55344-7701, US

(21) Appl. No.: 09/978,431

(22) Filed: Oct. 15, 2001

Related U.S. Application Data
(63) Continuation of application No. PCT/EP99/02855, filed on Apr. 27, 1999.

(51) Int. Cl. H04Q 7/20

(52) U.S. Cl. 455/461; 455/433; 455/414; 455/560

(57) ABSTRACT

A method and system for distributing IN services to a mobile network is described, wherein a service trader function is provided in the mobile network, the service trader function being arranged for providing a location or identification information of distributed IN services. The service trader function is checked when a location update procedure is performed or when an IN service is triggered at the visited network. Thereby, the IN service can be triggered at the visited network based on the checking result, such that the signaling load at the home network can be reduced.

### FIELD OF THE INVENTION

The present invention relates to a method and system for distributing IN services to a mobile network such as the GSM (Global System for Mobile Communications) or GPRS (General Packet Radio Service) network or any packet data network.

### BACKGROUND OF THE INVENTION

Currently, competing telecommunication network operators feel a strong need to differentiate. This may be achieved by sophisticated operator and provider specific telecommunication services. However, the support of non-standardized services within a strong standardized system such as the GSM cannot be solved easily.

To achieve this, the CAMEL (Customized Applications for Mobile network Enhanced Logic) feature has been provided in the GSM system in order to allow network operators to provide access to all the subscribed services including operator specific services even when the user roam internationally. Furthermore, the CAMEL feature introduces IN technology to GSM networks to thereby strengthen the GSM service delivery capabilities. The CAMEL feature is not a supplementary service, it is a phased network feature, which aligns with the IN SSF/SCF (Intelligent Network Service Switching Function/Service Control Function) interface. However, according to the CAMEL features, IN services are executed only in the home network of a subscriber. Thus, the signaling load through the home network increases due to the downloading of widely used IN services at the home network. Moreover, some IN services may require components in the visited network, because e.g. in the case of charging services, a part of the service logic is known only in the visited network and may not be revealed to the home network.

It is to be noted that, throughout the present invention, IN designates any solution in which a call, connection or session processing node contacts a service control function which issues instructions to the respective node. The contact to the service control function is based on a trigger information stored in the respective nodes. The trigger information may specify situations in the course of a call, connection or session handling. The service control function may be internally distributed. Moreover, the corresponding IN protocol could be any protocol between a controlling entity, such as a service controller (e.g. CAMEL Service Environment, CSE), responsive to a triggering from a call, and a session or connection processing node. The IN protocol may be e.g. an object oriented interface where the operations are object methods or invocations.

### SUMMARY OF THE INVENTION

It is therefore an object of the present invention to provide a method and system for distributing IN services, by means of which IN services may also be executed in the visited network.

This object is achieved by a method for distributing IN services to a mobile network, comprising the steps of:

providing a service trader function in the mobile network, the service trader function providing a location information of distributed IN services;

checking the service trader function, when a location update procedure is performed; and

updating a service trigger information in accordance with the checking result.

Additionally, the above object is achieved by a system for distributing IN services to a mobile network, comprising:

service trader means for providing a location information of distributed IN services;

location register means for checking the service trader means in response to a location update procedure,

wherein the location register means is arranged to update a service trigger information in accordance with the checking result.

Accordingly, a location information of a triggered IN service can be obtained at the home network of the corresponding subscriber, such that a corresponding service trigger information can be updated at the home location register of the subscriber and supplied to the visitor location register of the visited network, to thereby perform downloading of the IN service at the visited network.

Preferably, the service trader function is at least provided in the home network of the mobile subscriber.

Furthermore, the service trader function may provide an information about networks and service control points to which IN services have been downloaded.

The service trigger information preferably may be a CAMEL subscription information. In this case, the location information provided by the service trader function comprises at least a gsmSCF address and a service key.

The service trader function may additionally comprise a function for searching an IN service on the basis of a subscriber language.

Furthermore, a rerouting to an actual location of the In service may be performed, when the IN service is not available at the location indicated by the location information. The rerouting can be performed by the service trader function or by a service controller such as the CAMEL Service Environment of the mobile network.

Alternatively, the updated service trigger information may comprise an address information of a service controller to be contacted in case the IN service is not available at the location indicated by the location information.

The location register means may be a home location register or a visitor location register of the mobile network.

The location information provided by the service trader function may comprise an information element indicating a home network resident part of the IN service. Preferably, the information element can be a transparent data block only interpretable by a service logic of the IN service of a visited network, or may comprise an address and a service key which identifies the service logic of the IN service of the home network.

Furthermore, the above object is achieved by a method for distributing IN services to a mobile network, comprising the steps of:

providing a service trader function in the mobile network, the service trader function providing a location information of distributed IN services;

checking the service trader function as to the location of an IN service, when the IN service is triggered; and

downloading the IN service in accordance with the checking result.

Additionally, the above object is achieved by a system for distributing IN services to a mobile network, comprising:

service trader means for providing a location information of distributed IN services; and

a mobile switching means for checking the service trader means as to the location of an IN service, when the IN service is triggered,

wherein the mobile switching means is arranged to perform downloading of the IN service in accordance with the checking result.

Accordingly, the service trader function is checked any time an IN service is triggered at the service mobile switching center of the concerned mobile subscriber. Thereby, the location information of the nearest IN service can be obtained at the currently visited network, such that the IN service can be downloaded and executed at the visited network.

Additionally, the service trader function may provide a function for selecting a voice service information. Thereby, the service trader function can be checked for voice services, when the subscriber needs to be connected to an announcement or a voice application.

Preferrably, the service trader function may be arranged to obtain a service controller address of an IN service in a visited network from a service controller of the visited network based on a home service controller address of the IN service, when the IN service is downloaded from the home network to the visited network. In this case, the service trader function may forward a trigger information to the service controller of the visited network, when the IN service is triggered.

The service trader means may be arranged as a separate network element. Thereby, any home location register or mobile switching means may access the service trader means in order to obtain the required IN service information.

Furthermore, the above object is achieved by a network element for a mobile network, comprising:

receiving means for receiving a checking request for a predetermined service; and

service trader means for providing an identification information of the predetermined service in response to the checking request.

The predetermined service may be a voice and/or announcement service, wherein the identification information can be an address information of the voice and/or announcement service. In this case, the voice and/or announcement service may be identified by using an application identifier or by describing an attribute. The checking request may be received from the CAMEL Service Environment.

Furthermore, the above object is achieved by a service controller comprising:

receiving means for receiving a service invocation from a service trader means (STF); and

means for performing an enquiry to a service means providing the invocated service, in response to said service invocation.

Accordingly, an IN service can be distributed to the visited network via a service controller of the visited network.

Preferably, the service controller is a CSE of a home network and the service means a CSE of a visited network. The service invocation may be an Initial Detection Point message.

### BRIEF DESCRIPTION OF THE DRAWINGS

In the following, the present invention will be described in greater detail on the basis of a preferred embodiment with reference to the accompanying drawings, in which:

FIG. 1 shows a block diagram of a mobile home network connected to a mobile visited network in which the mobile subscriber is located, according to the preferred embodiment of the present invention;

FIG. 2 shows a transmission and processing diagram in accordance with the preferred embodiment of the present invention; and

FIG. 3 shows a transmission and processing diagram according to an alternative example of the preferred embodiment according to the present invention.

### DESCRIPTION OF THE PREFERRED EMBODIMENT

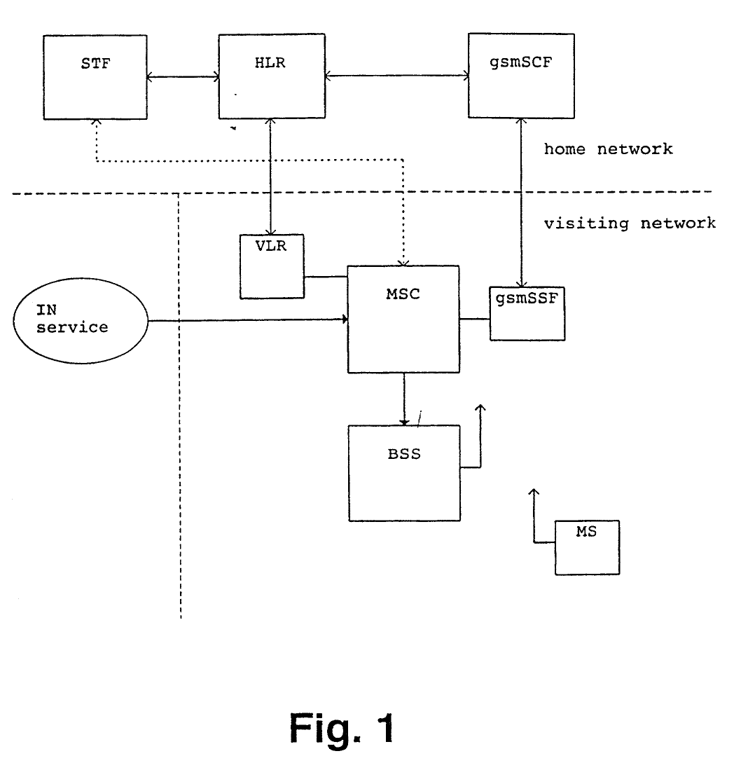

In the following, the preferred embodiment of the method and system according to the present invention will be described on the basis of a GSM system as shown in FIG. 1.

According to FIG. 1, a mobile home network (HPLMN, Home Private Land Mobile Network) comprises one or several HLRs (Home Location Registers), the number of which depends on the number of mobile subscribers, the capacity of the equipment and the organization of the network. All subscription data is stored there. The main information stored therein concerns the location of each mobile subscriber (MS) in order to be able to route calls to the mobile subscribers managed by the HLR. All management interventions occur on this database. The HLRs have no direct control of mobile switching centers (MSCs).

The HLR is connected to a GSM service control function (gsmSCF) which is a functional entity containing the CAMEL service logic to implement an operator specific service. The HLR stores an originating or terminating CAMEL subscription information (O/T-CSI) for subscribers requiring CAMEL support. The O-CSI is sent to a visitor location register (VLR) of a visited network in case a location update is performed or the O-CSI is updated. Furthermore, the O/T-CSI is sent to a gateway mobile switching center (GMSC, not shown) when the HLR responds to a request for routing an information.

Furthermore, the gsmSCF is connected to a GSM service switching function (gsmSSF) which is a functional entity that interfaces a mobile switching center (MSC) of the visited network to the gsmSCF.

When processing the calls for subscribers requiring CAMEL support, the MSC receives an O-CSI from the VLR, indicating the MSC to request an instruction from the gsmSSF. The MSC monitors on request the core states (events) and informs the gsmSSF of these states during processing, enabling the gsmSSF to control the execution of the call in the MSC. The VLR stores the O-CSI as a part of the subscriber data for mobile subscribers roaming in the VLR area.

The gsmSCF is arranged to control a call in the gsmSSF of the visited network, based on a request for instructions transmitted from the gsmSSF to the gsmSCF.

The MSC is connected to a base station subsystem (BSS) which is radio-connected to the MS.

According to the preferred embodiment, an IN service trader function (STF) is added to the home network of the MS. However, alternatively, the STF may be located in the visited network or generally on the signaling link between the visited network and the home network.

The STF may be a function provided in the HLR or may be arranged as a separate network element connected to the HLR. The STF may also communicate with the HLR via a service controller, e.g. a CAMEL Service Environment (CSE) in the GSM system, or may be implemented in association with such a service controller. The STF stores and updates locations of distributed IN services. Furthermore, an information about networks and service control points (SCPs) to which IN services have been downloaded may be contained in the STF. Additionally, the STF may provide a function for searching an IN service based on other criteria such as a subscriber language of the MS.

According to a first example of the preferred embodiment, the subscriber's service sets are checked by the HLR, when a location update procedure is performed between the HLR and the VLR of the visited network, or at least when the visited network has changed since the last location update.

Based on the IN service information returned from the STF, the HLR updates its service trigger information such as the CSI in the subscriber data, and supplies it to the VLR of the visited network. Thereby, the MSC of the visited network may obtain the corresponding updated subscriber service trigger information from its VLR, such that a required IN service can be executed at the visited network. The IN service may have been already downloaded to the visited network at an earlier time. In this case, the service is downloaded and configured to the service controller, e.g. CSE, of the visited network. Several possibilities exist for the implementation: manual operator service management actions may be provided, the home network may calculate an amount of roamers or an amount of triggerings from a particular visited network and may initiate downloading actions to transfer the service logic from the service controller of the home network to a service controller of the visited network. Then, the STF is udated and starts providing addresses of the new service controller to e.g. the HLRs.

The IN service may as well be downloaded in the course of a triggering or location update. This can be done e.g. during location updating, as long as it is fast enough. Then, the address to the downloaded IN service is provided. Alternatively, if downloading cannot be performed fast enough, the service logic is downloaded by the home network after a location update, and the triggers are then separately updated at a later stage in the HLR and the visited network by the home network.

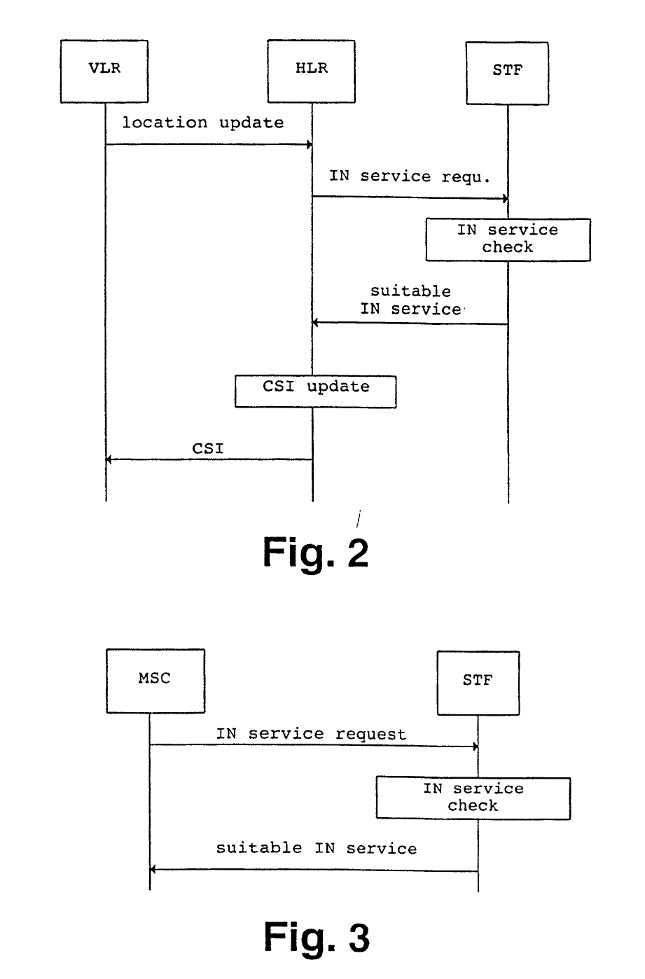

FIG. 2 shows a transmission and processing diagram of the corresponding signaling performed between the VLR, HLR and STF according to the first example of the preferred embodiment.

When a location update request is received by the HLR from the VLR, the HLR transmits an IN service request to the STF in order to initiate a check of the respective IN services triggered for the corresponding MS. The IN service request may comprise one or a plurality of service identifiers each specifying predetermined attributes describing a respective IN service. These attributes may comprise e.g. a user language, a visited network identity, an actual time and date, a user identity, a service price, a service price limit, and the like. The STF may also determine the service address based on the number of references given per service and service controller. Thereby, the load can be distributed in an even manner among alternative service controllers. The CSE could be internally distributed so as to comprise several entities or nodes to which the service logic has been distributed. However, from the MSC's point of view, it can be observed as a single entity

The STF performs an IN service check and returns a location or identification information concerning IN services suitable for the present location of the MS to the HLR. In particular, the information may concern the corresponding nearest IN services and may at least contain the corresponding gsmSCF address and service key.

Based on the received IN service information, the HLR updates its trigger information, i.e. the CSI in the subscriber data of the concerned MS. Furthermore, the HLR returns the updated subscriber information, e.g. the CSI, to the VLR, such that the information about the suitable IN service is provided at the visited network.

The updated subscriber information may be transmitted by an Insert Subscriber Data message to which the VLR responds with an Insert Subscriber Data Response message. Finally, the HLR may transmit an Update Location Response message to indicate the completion of the update procedure.

Furthermore, the service location information provided by the STF to the HLR and downloaded to the VLR, e.g. by the Insert Subscriber Data message, may contain an information element which enables the service contacted (which may be located in the visited network) to find the home network resident part of the service and to initiate a chained inquiry to the home network service controller, i.e. the home CSE in the GSM. In particular, the information element may be a transparent block of data only understood or interpretable by the service logic of the service controller (i.e. CSE) of the visited network. Alternatively, the information element may contain an explicit home address, i.e. SCF address in the GSM, and a home service key, i.e. SCF service key in the GSM, which identifies the service logic in the home network. In general, the service key identifies a service logic program, application or higher level protocol entity within a service controller (i.e. CSE). If the actual service can be identified without service key, only the service controller address is required.

Thus, after an Insert Subscriber Data message containing the above mentioned information element has been received by the VLR, an Initial Detection Point message containing the information element with the home SCF address and service key is transmitted from the VLR to the corresponding CSE of the visited network. Based on the received information element, the CSE of the visited network performs an inquiry to the SCF address of the home network by using the home SCF service key and receives a corresponding inquiry.

According to a second example of the preferred embodiment, the STF may be checked during the location update at the VLR, or at least if the visited network has changed since the last location update. Thus, the VLR is arranged to perform the STF checking operation.

According to the second example, the HLR may transmit an Insert Subscriber Data message to the VLR after having received a location update request from the VLR. Then, the VLR transmits an IN service request containing the above mentioned service identifier(s) and attributes. In this example, the service identifier may be just the default CSI returned by the HLR. The attributes may be omitted in a simplified implementation.

Having received the IN service request and performed the service check, the STF responds with the corresponding service identification or location information. Finally, the VLR transmits an Insert Subscriber Data Response message to the HLR which then responds with an Update Location Response message.

In general, the STF contact from the HLR or VLR may also be performed during a separate trigger profile downloading process. The VLR and HLR may also be specific service registers storing a user-specific service information. In particular, the HLR may store a user's service list describing the service attributes and service identifiers. The HLR and the STF may be combined, such that the service trader function is located within the service register (i.e. HLR).

Furthermore, it is possible in the above described first and second examples that the service location information has already expired. Therefore, if the service is not available for a service controller (i.e. CSE) indicated by the STF, the IN triggering may be rerouted to another CSE. This may be performed e.g. in such a way that the CSE provides a rerouting function to a CSE to which the IN service has been migrated, wherein the Initial Detection Point message is either routed directly from the visited CSE or returns back the new CSE address.

Alternatively, the STF may be contacted during the triggering time and provided with the service identifier and optionally with the original CSE address. The STF then supplies the address to the CSE to which the service has been migrated.

As a further alternative, the CSI downloaded from the HLR to the VLR may provide a “fallback” CSE address which is contacted in case the IN service is not available under the first address.

Preferably, the STF is updated after the service migration from the home network to the visited network, in order to provide a correct routing to the service.

According to a third example of the preferred embodiment, the MSC of the visited network may be directly connected to the STF, as shown by the dotted arrow in FIG. 1. Alternatively, the STF may be an own network element of the visited network. Thus, in the third example, the MSC may directly access the STF in order to obtain the required IN service information.

FIG. 3 shows a corresponding transmission and processing diagram of the signaling performed in the third example of the preferred embodiment.

According to FIG. 3, the MSC transmits an IN service request containing a service identifier and corresponding attributes to the STF when it has encountered a service trigger information, such as a trigger detection point specified in the CSI and indicating that an IN service is to be triggered at the visited network. In response to the received IN service request, the STF performs an IN service check based on the subscriber information contained in the IN service request. Then, the STF returns the resulting information about the suitable IN service to the MSC, which performs a processing for downloading and executing the corresponding IN service based on the received checking result. This may be achieved in the GSM by transmitting an Initial Detection Point message to the corresponding CSE.

According to a fourth example, the MSC may transmit an Initial Detection Point message directly to the STF, after having encountered the service trigger information. In this case, the Initial DP message contains the service identifier and corresponding attributes. Based on this information, the STF transmits a corresponding Initial DP message specifying the service location information of the triggered service to the corresponding CSE.

When a home network service controller (i.e. home CSE) performs downloading of a service logic (with home SCF address and service key) to a visited network service controller (i.e. visited CSE), the visited network controller adds a translation entry (home SCF address, service key) to the visited SCF address. Thus, the STF may obtain the visited network service controller address (i.e. visited SCF address) from the visited network service controller based on the home network service controller address (i.e. home SCF address) and the home network service key (i.e. home SCF service key).

When the MSC then transmits an Initial DP message containing the home SCF address and the home network service key to the STF, in case of an encountered service trigger information, the STF is able to translate the home SCF address and the service key into the visited SCF address. Then, the STF corrects the destination address of an Initial DP message into the obtained visited SCF address and forwards the corrected Initial DP message to the concerned visited network service controller. Optionally, the home network service key may also be encapsulated within the forwarded Initial DP message. Based on the received home network service controller address and home network service key, the visited network service controller may then perform an enquiry to the home network service controller in order to obtain the required service information from the home network service controller.

The STF may be arranged to understand only SCCP (Signaling Connection Control Part) level signaling used to set-up, manage and tear down connections as well as to exchange non-connection associated information, and to recognize an Initial Detection Point message. Preferably, all INAP (Intelligent Network Application Profile) signaling or just Initial DP (Detection Point) messages to a given network or set of networks should be routed via a given STF which also acts as an SCCP level relay. The Initial DP message refers to a message by means of which a service logic is invoked for the first time in a call or session.

According to the preferred embodiment, the STF may also be checked for voice services, when there is a need to connect the MS to an announcement or a voice application. This may be the case if a voice or announcement service has migrated to another network, i.e. to a network node which may be accessed more easily from the visited network. The voice and/or announcement services can be identified by using an application identifier or describing attributes.

In particular, the signaling may be performed such that the MSC transmits an Initial Detection Point message to the corresponding service controller (i.e. CSE), after it has encountered a service trigger information such as a trigger detection point. The CSE then transmits a service request containing one or a plurality of application identifiers with respective attributes to the STF which subsequently returns the corresponding voice application addresses. Thereafter, the CSE transmits a message for establishing a temporary connection to the MSC which then performs a temporary connection setup to the specified voice application.

According to the preferred embodiment of the present invention, IN services can be triggered at the visited network, such that the signaling load at the home network can be reduced and the service logic can be directly derived at the visited network.

It is to be pointed out that the service distributing method and system described in the preferred embodiment can be applied to any packet data network in which an IN service can be triggered. Thus, the CAMEL architecture can be any IN architecture. Moreover, the MSC can be, for example, a VoIP gatekeeper with SSP (Service Swirching Point) functionality. Thus, the above description of the preferred embodiment and the accompanying drawings are only intended to illustrate the present invention. The preferred embodiment of the invention may vary within the scope of the attached claims.

In summary, a method and system for distributing IN services to a mobile network is described, wherein a service trader function is provided in the mobile network, the service trader function being arranged for providing a location or identification information of distributed IN services. The service trader function is checked when a location update procedure is performed or when an IN service is triggered at the visited network. Thereby, the IN service can be triggered at the visited network based on the checking result, such that the signaling load at the home network is reduced.

1. A method for distributing IN services between mobile networks, comprising the steps of:
a) providing a service trader function in at least one of said mobile networks, said service trader function providing a location information of distributed IN services;
b) checking said service trader function, when a location update procedure is performed; and
c) updating a service trigger information in accordance with the checking result.

2. A method according to claim 1, wherein said service trader function is provided at least in the home network of a mobile subscriber.

3. A method according to claim 1 or 2, wherein said service trader function provides an information about networks and service control points to which IN services have been downloaded.

4. A method according to any one of the preceding claims, wherein said service trigger information is a CAMEL subscriber information.

5. A method according to claim 4, wherein said location information provided by said service trader function comprises at least a gsmSCF address and a service key.

6. A method according to any one of the preceding claims, wherein said trader function comprises a function for searching an IN service on the basis of a subscriber language and/or service attributes.

7. A method according to any of the preceding claims, further comprising the step of performing a rerouting to an actual location of said IN service, when said IN service is not available at the location indicated by said location information.

8. A method according to claim 7, wherein said rerouting is performed by said service trader function.

9. A method according to claim 7, wherein said rerouting is performed by a service controller of said mobile network.

10. A method according to claim 9, wherein said service controller is the CSE of the GSM.

11. A method for distributing IN services to a mobile network, comprising the steps of:
a) providing a service trader function in said mobile network, said service trader function providing a location information of distributed IN services;
b) checking said service trader function, as to the location of an IN service, when said IN service is triggered; and
c) sending the IN service invocation to the location of said IN service.

12. A method according to claim 11, wherein said IN service is downloaded from said location of said IN service.

13. A method according to claim 11 or 12, wherein said checking step is performed in a mobile switching center (MSC).

14. A method according to any one of claims 11 to 13, wherein said service trader function (STF) is arranged to obtain a service controller address of an IN service in a visited network based on a home service controller address of said IN service, when said IN service is downloaded from the home network to said visited network.

15. A method according to any one of claims 11 to 13, wherein said service trader function provides a function for selecting a voice service information.

16. A system for distributing IN services to a mobile network, comprising:
a) service trader means (STF) for providing a location information of distributed IN services; and
b) location register means (HLR) for checking said service trader means (STF) in response to a location update procedure;
c) wherein said location register means (HLR) is arranged to update a service trigger information in accordance with the checking result.

17. A system according to claim 16, wherein said location register means is a home location register (HLR) of said mobile network.

18. A system according to claim 17, wherein a trigger information obtained from said home location register (HLR) comprises an information element indicating a home network resident part of said IN service.

19. A system according to claim 18, wherein said information element is provided by said trader means (STF).

20. A system according to claim 18 or 19, wherein said information element is stored in said home location register (HLR).

21. A system according to any one of claims 18 to 20, wherein said information element is a transparent data block only interpretable by a service logic of said IN service of a visited network.

22. A system according to any one of claims 18 to 20, wherein said information element comprises an address and a service key which identifies a service logic of said IN service in the home network.

23. A system according to claim 16, wherein said location register means is a visitor location register (VLR) of said mobile network.

24. A system according to any one of claims 16 to 23, wherein said service trader means (STF) is arranged in the home network of a mobile subscriber to which an IN service is to be provided.

25. A system according to any one of claims 16 to 24, wherein said update service trigger information comprises an address information of a service controller to be contacted in case said IN service is not available at the location indicated by said checking result.

26. A system for distributing IN services to a mobile network, comprising:
a) service trader means (STF) for providing a location information of distributed IN services; and
b) a mobile switching means (MSC) for checking said service trader means (STF) as to the location of an IN service, when said IN service is triggered;
c) wherein said mobile switching means (MSC) is arranged to perform downloading of the said IN service in accordance with the checking result.

27. A system according to claim 26, wherein said service trader means (STF) is arranged to obtain a service controller address of an IN service in a visited network from a service controller of said visited network based on a home service controller address of said IN service, when said IN service is downloaded from the home network to said visited network.

28. A system according to claim 27, wherein said service trader means (STF) forwards a trigger information to said service controller of said visited network in response to said checking by said mobile switching means (MSC).

29. A system according to any one of claims 26 to 28, wherein said service trader means (STF) is arranged as a separate network element.

30. A network element (STF) for a mobile network, comprising:
a) receiving means for receiving a checking request for an IN service; and
b) service trader means for providing an identification information of said IN service in response to said checking request.

31. A network element according to claim 30, wherein said IN service is a voice and/or announcement service, and said identification information is an address of said voice and/or announcement service.

32. A network element according to claim 31, wherein said voice and or announcement service is identified by using an application identifier or by describing an attribute.

33. A network element according to claim 31 or 32, wherein said checking request is received from a CSE of the GSM.

34. A service controller comprising:
a) receiving means for receiving a service invocation from a service trader means (STF); and
b) means for performing an enquiry to a service means providing the invocated service, in response to said service invocation.

35. A service controller according to claim 34, wherein said service controller is a CSE of a home network and the service means is a CSE of a visited network.

36. A service controller according to claim 34 or 35, wherein said service invocation is an Initial Detection Point message.
